(19) United States
(12) Patent Application Publication
(10) Pub. No.: US 2022/0085683 A1
(43) Pub. Date: Mar. 17, 2022

(54) ELECTRIC MOTOR FOR DRIVING WORKING MACHINES HAVING MEDIA SEPARATION

(71) Applicant: ebm-papst St. Georgen GmbH & Co. KG, St. Georgen (DE)

(72) Inventors: Michael KISCH, St. Georgen (DE); Wilhelm WEISSER, Königsfeld/Buchenberg (DE); Jens LÖFFLER, Villingen-Schwenningen (DE); Jochen SCHEFFCZYK, Villingen-Schwenningen (DE); Marcus HELLMANN, Unterkirnach (DE); Michael BITZER, St. Georgen (DE)

(21) Appl. No.: 17/419,953

(22) PCT Filed: Dec. 10, 2019
(86) PCT No.: PCT/EP2019/084501

§ 371 Date: Jun. 30, 2021

(30) Foreign Application Priority Data
Jan. 30, 2019 (DE) 102019102368.8

(51) Int. Cl. H02K 5/128; H02K 1/30; H02K 5/173; H02K 5/18; H02K 9/22; H02K 11/33; H02K 21/16

(52) U.S. Cl. CPC H02K 5/128; H02K 1/30; H02K 5/1732; H02K 2211/03; H02K 9/227; H02K 11/33; H02K 21/16; H02K 5/18

(57) ABSTRACT

The disclosure relates to an electric motor comprising a motor casing (2) that includes a shaft portion for accommodating a motor shaft (4), and a motor portion in which motor electronics (5) and motor windings (6) are arranged, the shaft portion and the motor portion being separated from each other in a sealed manner by a can (7) that is arranged in the motor casing (2). An inner rotor and, axially adjacent thereto, a metal ball bearing pot (8) are arranged in the shaft portion of the can (7), and a ball bearing (9) for mounting the motor shaft (4) is secured in the ball bearing pot (8).

### RELATED APPLICATIONS

This application is a national stage application that claims priority to PCT/EP2019/084501, filed Dec. 10, 2019, and German Patent Application No. 10 2019 102 368.8, filed Jan. 30, 2019, the entire contents of which are incorporated herein by reference in their entirety.

### FIELD

The disclosure relates to an electric motor for driving machines that have essential media separation, as is the case, for example, in pumps, centrifuges, or separators.

### BACKGROUND

In electric motors of this kind that produce a high rotation speed of the motor shaft, the power dissipation of the ball bearing supporting the motor shaft increases noticeably due to a powerful heat buildup. Especially in compact embodiments of the electric motor in which the ball bearing is positioned directly adjacent to many other components, the generated heat cannot be dissipated to a sufficient degree.

The object of the disclosure, therefore, is to provide an electric motor as a drive unit for machines that have media separation, which in addition to a separation of motor electronics from the motor shaft, has an improved heat dissipation for the ball bearing supporting the motor shaft.

This object is attained by the combination of features according to claim 1.

### BRIEF SUMMARY

According to the disclosure, an electric motor with a motor housing is proposed, which has a shaft section for accommodating a motor shaft and a motor section for accommodating motor electronics and motor windings. The shaft section and the motor section are isolated from each other in a sealed fashion by means of a split pot positioned in the motor housing in order to ensure the media separation. In the shaft section, an internal rotor and axially adjacent thereto, a metallic ball bearing cup, are positioned in the split pot; a ball bearing for supporting the motor shaft and the internal rotor is mounted in the ball bearing cup. The internal rotor is specially embodied and has a shaft passage that forms an axial stop surface. For example, the axial stop surface can be produced by means of a recess in the inner circumference surface, which forms a step. In addition, a press-fitted bushing is positioned in the shaft passage, resting against the stop surface, into which bushing the motor shaft can be pressed.

The shaft passage is preferably produced by means of a plastic extrusion coating of a ferrite permanent magnet, into which the press-fitted bushing can be pressed with a radial expansion and accompanying enlargement of its outer diameter by at least a little in the radial direction.

The split pot is used to isolate the shaft section from the motor section and to prevent a gas exchange between the crank case and the electronics and motor windings. A suitable material is polyphenylene sulfide, for example.

The split pot with the ball bearing cup accommodated in it, however, results in a design in which the ball bearing must be tightly packed in a central position and is unable to dissipate outward much of its heat that is generated during operation. According to the disclosure, the heat dissipation takes place through a connection of the split pot and ball bearing cup with the ball bearing accommodated therein to the motor housing, in particular to the housing cover.

In one embodiment of the electric motor, the split pot is integrally formed by the motor housing around a rotation axis of the motor shaft. This ensures a seal without additional sealing elements. In particular, the motor housing forms a surrounding outer wall, which is adjoined on an axial side by an axial wall into which the split pot is sunk. The split pot is preferably embodied in the form of a hollow cylinder with sections of different diameters, with the ball bearing cup being accommodated in the section that protrudes the farthest into the motor housing.

In this connection, an advantageous embodiment is one in which the split pot and the ball bearing cup are embodied as identically shaped in the section of the split pot in which the ball bearing cup is positioned. In other words, the ball bearing cup and the split pot define the same outer contours.

In a first embodiment variant, a gap between the housing cover and the split pot has a gap dimension of zero. The housing cover therefore rests directly against the split pot. The ball bearing cup which is once again accommodated in the split pot is thus likewise directly connected to the housing cover so that the heat is conducted away from the ball bearing cup via the split pot to the housing cover and to the surrounding environment.

In an alternative embodiment, the gap between the housing cover and the split pot has a small gap dimension, which is up to a magnitude of 1/20 of the maximum outer diameter of the ball bearing. The small gap has hardly any negative effect on the heat dissipation from the ball bearing cup to the housing cover, but permits a relative positioning of the components without contact.

Another advantageous embodiment of the electric motor is one in which a heat-conducting paste or a heat-conducting adhesive is provided between the split pot and the housing cover. The heat-conducting paste preferably constitutes an intermediate layer and enables a thermal connection of the housing cover to the split pot without the components touching each other. Vibrations of the individual components thus remain decoupled from each other. With the use of a heat-conducting adhesive, in addition to the advantageous effect of the heat-conducting paste, it is possible to produce a glued connection of the housing cover to the split pot.

In an exemplary embodiment, the housing cover is detachably fastened to the motor housing and is placed on an axial side of the rest of the motor housing. The housing cover thus forms the section of the motor housing that is connected indirectly via the split pot to the ball bearing cup and thus to the ball bearing. If the split pot is embodied as integral to the motor housing, then the mounting of components of the electric motor can be carried out by means of the side axially opposite from the split pot, on which the housing cover is removably positioned. At the same time, the embodiment with a housing cover functioning as a heat sink provides the large area for the heat dissipation to the surrounding environment.

On the motor housing, an integral connector with connections to the motor electronics is also advantageously provided, into which customer-specific plugs can be inserted. The communication interface can also be integrated into the connector.

The heat dissipation capacity in the electric motor is further improved in a variant in which the housing cover has a cooling element protruding axially in the direction of the surrounding environment, which locally enlarges the cooling surface area of the housing cover. Preferably, the cooling element on the housing cover is embodied as a plurality of cooling fins that are distributed over the housing cover. In particular, the cooling fins can be embodied as integral to the housing cover or alternatively, can be fastened to it in an integrally bonded way. In this connection, it is also advantageous if, viewed in the axial projection, a plurality of the cooling fins extend across the ball bearing cup so that the locally accumulating heat in the ball bearing cup is conducted to the surrounding environment in a particularly quick and effective way.

In one embodiment of the electric motor, the heat dissipation capacity is also improved in the opposite axial direction, i.e. oriented toward the split pot, in that a heat sink is embodied on the housing cover, which protrudes toward the ball bearing cup and which locally enlarges a mounting surface on the ball bearing cup indirectly via the split pot.

In an advantageous embodiment, the heat sink is embodied as cylindrical or conical, with an axial mounting surface on an axial outer wall surface of the split pot. As a result, the heat of the ball bearing is transmitted from the ball bearing cup to the split pot and then from the latter's axial outer wall surface to the mounting surface of the cylindrical heat sink and finally to the entire surface area of the housing cover including the cooling elements.

The heat dissipation is also promoted by the fact that the housing cover is made of metal or heat-conducting plastic.

In a preferred embodiment, the ball bearing cup forms a ball bearing seat into which the ball bearing is press-fitted.

In addition, one variant of the electric motor is characterized in that the ball bearing cup has an open space between the ball bearing and the section of the motor housing that is connected to the surrounding environment. The ball bearing can therefore dissipate heat directly to the air in the open space and is not in direct contact with the axial surface of the ball bearing cup, which rests against the split pot and the heat sink.

Furthermore, in a modification, in the electric motor, the split pot extends axially through the motor housing to the housing cover. Thus in the axial direction, i.e. along the rotation axis of the motor shaft, the split pot defines a considerable part of the centrally positioned inner motor housing around the rotation axis. Preferably, the split pot extends in the axial direction over 60-95%, more preferably over 70-95%, even more preferably over 80-90% of the total axial length of the motor housing.

Another advantageous exemplary embodiment is one in which the motor housing and the split pot are made of plastic and the metallic ball bearing cup is extrusion coated with the plastic directly in the injection molding process.

To achieve a compact design, in the electric motor, the windings advantageously encompass the split pot in the circumference direction. At the same time, it is advantageous that the windings are positioned spaced axially apart from the ball bearing. As a result, the heat generation of the motor windings remains separate from that of the ball bearing.

For a compact design of the electric motor, it is also advantageous that the motor electronics are positioned axially on one side of a printed circuit board, which has a central opening, and the heat sink protruding from the housing cover extends through the central opening. Alternatively, the split pot extends through the central opening.

### BRIEF DESCRIPTION OF THE DRAWINGS

Other advantageous embodiments of the disclosure are disclosed in the dependent claims and will be explained in greater detail below along with the description of the preferred embodiment of the disclosure based on the figures. In the drawings:

FIG. 1 shows a lateral cutaway view through an electric motor of an exemplary embodiment;

FIG. 2 shows a detail view from FIG. 1.

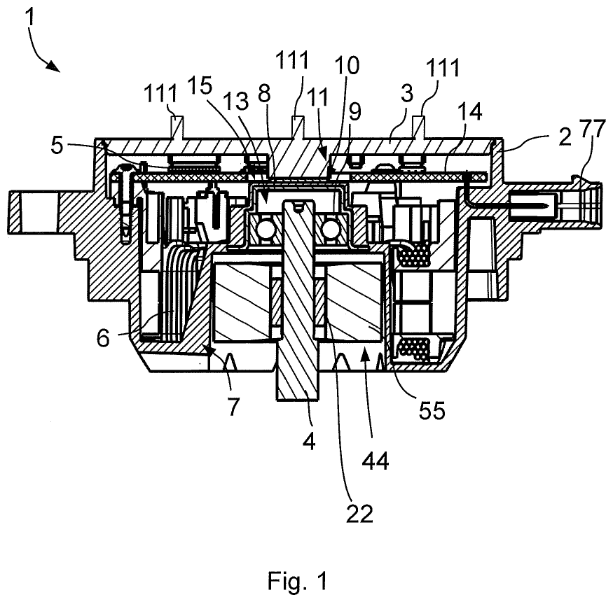

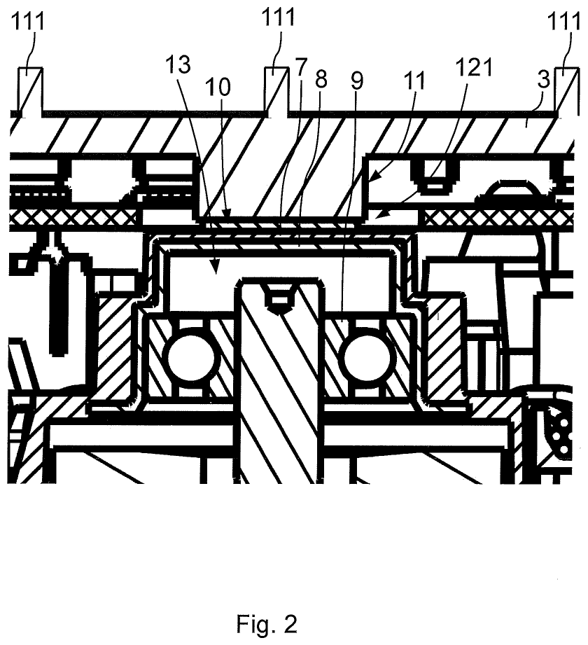

In FIGS. 1 and 2, an exemplary embodiment of an electric motor according to the disclosure 1 is respectively shown in a lateral cutaway view and a detail view.

### DETAILED DESCRIPTION

The electric motor 1 includes the one-piece motor housing 2 made of PPS (polyphenylene sulfide) with the housing cover 3, which can be fastened axially to the motor housing 2 and in the fastened state, constitutes a part of the motor housing. On the side axially opposite from the housing cover 3, the motor housing 2 integrally forms the split pot 7 that extends axially into the inside of the motor housing 2. Between the inner wall of the motor housing 2 and the outer casing of the split pot 7 is the motor section that accommodates the motor windings 6 and the motor electronics 5 that are fastened axially to one side of the printed circuit board 14. The components of the motor electronics 5 extend into cavities of the motor section in the direction of the motor windings 6. Inside the split pot 7 and isolated in a sealed fashion by means of the split pot 7 is the shaft section, which comes into contact with media conveyed by the machines and inside which the motor shaft 4 extends along its rotation axis. The split pot 7 extends in the axial direction essentially through the entire motor housing 2 to the housing cover 3. In addition, the motor housing 2 has a connector 77 integrated into it, with connections, which are connected to the motor electronics 5 on the printed circuit board 14, for connecting to customer-specific plugs.

In the shaft section, the internal rotor 44 is positioned in the split pot 7 and its ferrite permanent magnet 55 is provided with an extruded plastic coating that defines its inner circumference surface, which forms the shaft passage for the motor shaft 4. The press-fitted bushing 22 rests against the inner circumference surface and is supported on an axial stop (not shown) to permit the motor shaft 4 to be press-fitted into position.

The ball bearing cup 8, which is made of a heat-conducting material, in particular metal, is positioned in the deepest section of the split pot 7 viewed in the axial direction. In the injection molding process, the plastic of the motor housing 2 with the split pot 7 is molded around the ball bearing cup 8 so that the split pot 7 and the ball bearing cup 8 have the same form or more precisely, the same respective inner and outer contours and rest directly against each other. The ball bearing cup 8 defines the bearing seat for the press-fitted ball bearing 9 in which the motor shaft 4 is supported. The open space 13 into which the free end of the motor shaft 4 extends is formed between the ball bearing 9 and the axial inner wall surface of the split pot 7.

Around the rotation axis, an integral heat sink 11 is embodied on the housing cover 3 in the form of a cylinder composed of solid material, which protrudes axially in the direction of the ball bearing cup 8. Situated axially between the heat sink 11 and the axial outer wall surface of the split pot 7 is the gap 121 with a gap dimension of at most 1/20 of the outer diameter of the ball bearing. In the embodiment shown, the gap 121 is provided with a layer of heat-conducting paste 10, for which a heat-conducting adhesive can also be substituted.

The heat generated by the ball bearing 9 during operation is dissipated from the ball bearing 9 to the ball bearing cup 8, then to the split pot 7 and in the axial direction via the heat-conducting paste 10 to the heat sink 11 of the housing cover 3 of the motor housing 2. The heat is then transmitted from the housing cover 3 to the surrounding environment. The motor housing and in particular its housing cover 3 thus function as a heat sink. In an alternative embodiment that is not shown, the heat-conducting paste 10 is omitted and the heat sink 11 contacts the split pot 7 directly. The gap 121 then has a gap dimension of zero.

The split pot 7 is embodied in the form of a hollow cylinder and is divided into three axial sections, each with a different inner diameter. The open space 13 is in the region of the smallest diameter, bearing seat with the ball bearing 9 is in the middle region, and the motor windings 6 are positioned radially around the split pot 7 in the region of the greatest inner diameter. The ball bearing 9 therefore does not overlap with the motor windings 6 when viewed in the axial direction.

Around the rotation axis of the motor shaft 4, the printed circuit board 14 defines the central opening 15 through which the heat sink 11, which protrudes axially from the housing cover 3, extends to the split pot 7 in the axial direction. In an alternative variant that is not shown, but is likewise part of the disclosure, instead of the heat sink 11, the region of the smallest diameter of the split pot 7 extends through the opening 15 or at least into the opening 15 so that the contact between the split pot 7 and the heat sink 11 is produced at the height of the printed circuit board 14 or axially above the printed circuit board 14. In another alternative embodiment, the housing cover 3 is embodied without a heat sink 11 and the split pot 7 is brought into contact with the axial inner wall of the housing cover 3 directly or via the heat-conducting paste 10 or the heat-conducting adhesive.

The housing cover 3 forms a plurality of cooling fins 111 that are distributed over its surface oriented toward the surrounding environment, some of which extend across the ball bearing cup 8 centrally, i.e. viewed in the axial projection. By means of this, the heat accumulating in the region of the ball bearing cup 8 is conducted to the surrounding environment more quickly.

1. An electric motor with a motor housing, which has a shaft section for accommodating a motor shaft and a motor section in which motor electronics and motor windings are positioned; the shaft section and the motor section are isolated from each other in a sealed fashion by means of a split pot positioned in the motor housing; in the shaft section, an internal rotor and axially adjacent thereto, a metallic ball bearing cup, are positioned in the split pot; a ball bearing for supporting the motor shaft is mounted in the ball bearing cup; the internal rotor has a shaft passage that forms an axial stop surface and a press-fitted bushing is positioned in the shaft passage, resting against the stop surface.

2. The electric motor according to claim 1, wherein the ball bearing cup rests indirectly via the split pot against a section of the motor housing that is in contact with the surrounding environment so that the motor housing functions as a heat sink and heat generated by the ball bearing during operation is conducted away via the ball bearing cup and via the split pot to the motor housing and the surrounding environment.

3. The electric motor according to claim 1, wherein the split pot is integrally formed by the motor housing around a rotation axis of the motor shaft.

4. The electric motor according to claim 1, wherein the split pot and the ball bearing cup are embodied as identically shaped in the section of the split pot in which the ball bearing cup is positioned.

5. The electric motor according to claim 1, wherein a heat-conducting paste or a heat-conducting adhesive is provided between the split pot and the housing cover.

6. The electric motor according to claim 1, wherein the motor housing has a detachable housing cover, which can be placed on an axial side of the rest of the motor housing and forms the section of the motor housing that is connected to the ball bearing cup indirectly via the split pot.

7. The electric motor according to claim 6, wherein the housing cover has at least one cooling element protruding axially in the direction of the surrounding environment, which locally enlarges a cooling surface area of the housing cover that is in contact with the surrounding environment.

8. The electric motor according to claim 7, wherein the at least one cooling element is embodied as a plurality of cooling fins that are distributed over the housing cover and at least one of the cooling fins extends across the ball bearing cup, viewed in the axial projection.

9. The electric motor according to claim 8, wherein the housing cover has a heat sink protruding axially in the direction of the ball bearing cup, which locally enlarges a mounting surface on the ball bearing cup indirectly via the split pot.

10. The electric motor according to claim 9, wherein the heat sink is embodied as cylindrical or conical, with an axial mounting surface on an axial outer wall surface of the split pot.

11. The electric motor according to claim 1, wherein the ball bearing cup forms a ball bearing seat into which the ball bearing is press-fitted or inserted.

12. The electric motor according to claim 1, wherein the ball bearing cup has an open space between the ball bearing and the section of the motor housing that is connected to the surrounding environment.

13. The electric motor according to claim 6, wherein the split pot and the ball bearing cup extend axially through the motor housing to the housing cover.

14. The electric motor according to claim 1, wherein the motor windings encompass the split pot in the circumference direction and are spaced axially apart from the ball bearing.

15. The electric motor according to claim 6, wherein the motor electronics are positioned axially on one side of a printed circuit board, which has a central opening that defines a direct flow connection between the split pot and the housing cover so that a heat generated by the ball bearing during operation can be transmitted directly to the housing cover.
